(19) United States
(12) Patent Application Publication
(10) Pub. No.: US 2014/0129295 A1
(43) Pub. Date: May 8, 2014

(54) SYSTEM FOR AUTOMATED PROCESS MINING

(71) Applicant: TIMEST LTD., Jerusalem (IL)

(72) Inventor: Noam BAND, Rosh Haayin (IL)

(73) Assignee: TIMEST LTD., Jerusalem (IL)

(21) Appl. No.: 13/668,435

(22) Filed: Nov. 5, 2012

(51) Int. Cl. G06Q 10/06

(52) U.S. Cl. CPC G06Q 10/0637
USPC 705/7.36

(57) ABSTRACT

The detection and interpretation of data pertaining to the usage of software and documents by end users, and more specifically, the automation of the mining of event logs of events generated by business processes for logging of business processes and automatic discovery of business process models.

### FIELD OF THE INVENTION

The present invention relates to the detection and interpretation of data pertaining to the usage of software and documents by end users, and more specifically, the automation of the mining of event logs of events generated by business processes for logging of business processes and automatic discovery of business process models.

### BACKGROUND OF THE INVENTION

At present, projects in the value of more than 100 Billion US dollars are deployed yearly in the US alone. Adopting a new application involves, in almost all cases, a massive change in business processes and a new way of working. Usually, a pilot project exposes end users to the new application, for trial, before all the users start to work with it. Yet, when organizations decide to roll out a new application, only rarely does this decision rely on objective measures of the pilot users, according to the critical business processes of the organizations. In most organizations the meaning of that is that on rollout phase the risk of the organization climbs dramatically, leaving the entire organization exposed to a huge failure of its critical processes on the first days of deployment. It is no secret that on those risky days most business processes are wrongly used and some are never used; and when some are used correctly, the extended user environment is disruptive to the effective utilization. It is almost impossible for organizations to know which processes are ready to rollout and which actions must be taken before rollout. Rollout is a critical phase in the process of enrollment of a new critical application in organizations. Although failure in this stage means harmful results to the organization (regardless of the funds and time invested in deploying the application) and may lead to total disaster, there are currently no automated tools to deal with this stage.

In light of the above, there remains an unmet long felt need for providing an objective, automated and rapid system and method for monitoring actual usage of a software product for the purposes of quality control or launching readiness and similar purposes.

A key to any successful method of analyzing business processes mined from an event log and business process models (BPMs), is the ability to efficiently compare such BPMs among themselves to the entries in a database of such BPMs. To this end, it is useful first of all to choose a well-defined representation for the BPMs (e.g., the XML Process Definition Language (XPDL) which is a standard supported by the Workflow Management Coalition (WfMC) consortium), and a compatible graphical displaying convention for the BPMs (e.g., the BPMN notation, which is the standard supported by the Object Management Group consortium). Next, it is imperative to define a metric, or distance function, on pairs of BPMs. To date, a great deal of proposed metrics for BPMs have been published (a good review of the state of the art as of 2011 is given in Remco M. Dijkman, Marlon Dumas, Boudewijn F. van Dongen, Reina Käärik, Jan Mendling: Similarity of business process models: Metrics and evaluation. Inf. Syst. 36 (2): 498-516 (2011) and M. Dumas, L. Garcia-Bañuelos and R. Dijkman. Similarity Search of Business Process Models, Data Engineering Bulletin 32 (3):23-28 (2009) and the references therein). The main methods currently known in the art for providing a BPM metric belong to one of the following categories: syntactic, semantic, structural and behavioral.

### SUMMARY OF THE INVENTION

It is an object of the present invention to automatically mine object usage logs for instances of business processes matching business process models (BPMs)in an updatable BPM database, and to store said instances in a second log. A further object of the present invention is to update said BPM library to include automatically generated new BPMs describing BPMs not matching any preexisting BPMs in the database.

It is a further object of the present invention to provide a system and a method for said automatic mining of object usage, by automatically interpreting object usage on a plurality of end users' computers comprising a plurality of computers used by end users (EUCs), a central server (server) with processing means and first information storage means adapted for storing: captured raw object data, an updatable library of object classes, computer readable instructions for identifying class-relevant and title-relevant information in raw object data and comparing to said library of object classes, or object models (OMs) and a log of OM instances, comprising data on class, title, time and duration of usage of said OM instances. In order to capture the raw object data, use is made of a plurality of listener devices (listeners) possessing a second information storage means and first means of communications with one or more EUCs, and adapted for obtaining from said EUCs information on object activity, and a second means of communication with server for passing said object usage information.

### BRIEF DESCRIPTION OF THE DRAWINGS

FIG. 1 is a schematic diagram illustrating an embodiment of a system for automatic business process mining.

FIG. 2 is a schematic diagram illustrating an embodiment of a system for automated object data measurement and analysis.

FIG. 3 is a schematic diagram illustrating an embodiment of automatic business process mining.

FIG. 4 is a schematic diagram illustration an embodiment of a method for automated object data measurement and analysis.

### DETAILED DESCRIPTION OF THE INVENTION

One straightforward approach to monitoring actual usage of a product by end users in a computerized business environment would be to store frequent screen shots of the end users' computers, and then go over them manually for interpretation and analysis. In practice, such a procedure would result in prohibitively large amounts of raw data and consequently tedious or even impracticable manual processing.

The present invention provides a means for automatically reducing the heaps of raw data into more manageable higher level information. Firstly, a log of data objects is created automatically, which is then itself mined for business processes. The system creates a candidate business process model (BPM) for processes running on the system and compares it to BPMs in a database. The database can initially contain business process models supplied by the manufacturer of the product to be tested, as well as standard libraries of BPMs, and is updated whenever a newly created BPM candidate is found to be substantially different from all BPMs in the database.

Logging and displaying the identified business processes. While efficiency and convenience of use dictate that the human user should be spared the tedium of the bulk of the data mining operations, the present invention does include a human feedback option, to enable the user to improve the automatic object and BPM identification algorithms by correcting errors (low level errors: incorrect object identification as well as higher level errors: incorrect business process identification).

In the preferred embodiment of the present invention, the BPMs are encoded in the XML Process Definition Language (XPDL) which is a standard supported by the Workflow Management Coalition (WfMC) consortium; and are displayed graphically.

In BPMN notation conforming to BPMN standard set by the Object Management Group consortium. Furthermore, the quantitative comparison of BPMs to BPM candidates is accomplished in the preferred embodiment using a structural similarity metric, representing the current state of the art (as given in Remco M. Dijkman, Marlon Dumas, Boudewijn F. van Dongen, Reina Käärik, Jan Mendling: Similarity of business process models: Metrics and evaluation. Inf. Syst. 36 (2): 498-516 (2011) and references therein). Optional corrections supplied by human user are used to correct OM instance logs and BPM instance logs, as well as finte tuning the parameters of said metric for optimal correlation of its results with human judgment.

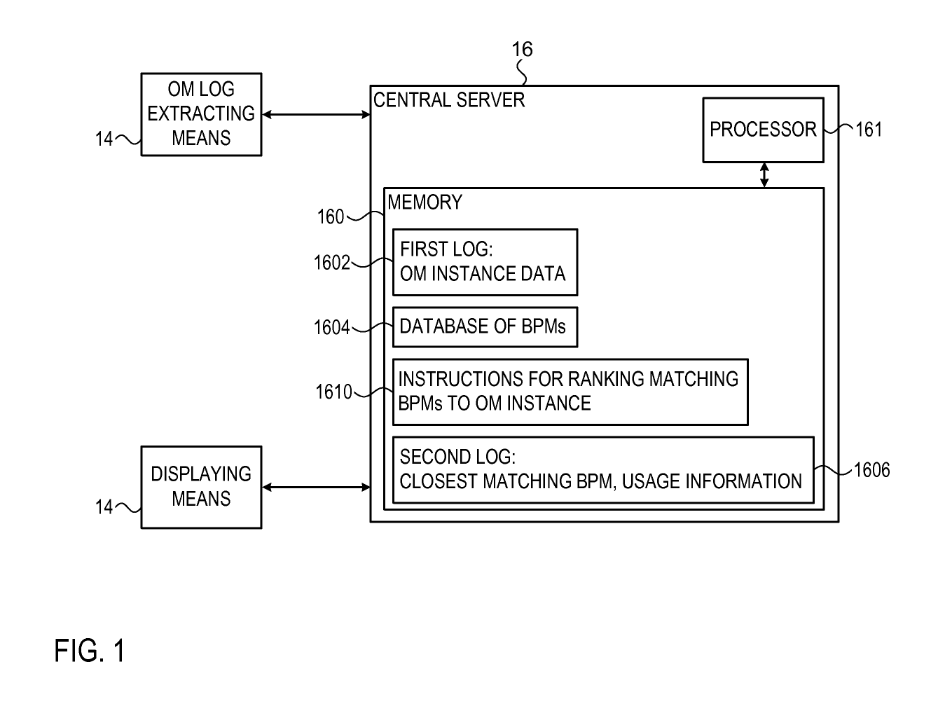

Example: The following example is a preferred embodiment of the present invention (FIG. 1). A system comprising a module (14) (described in detail below) for extracting a log of object model (OM) instances; a computer readable medium (160) containing: an OM instance log (1602) obtained from said extracting means; a first database containing a plurality of business process models (BPMs) (1604) encoded in XPDL; instructions (1610) for automatically ranking according to a structural similarity metric, the matching of the contents of said OM instance log to at least one of said plurality of said business process models; a second log (1606) of closest match for each of said OM instance, according to said ranking; and a displaying means (14) for displaying said log closest match displayed graphically in BPMN, wherein said OM instance log derives from a second system for automatically interpreting screen usage on a plurality of end users' computers as follows:

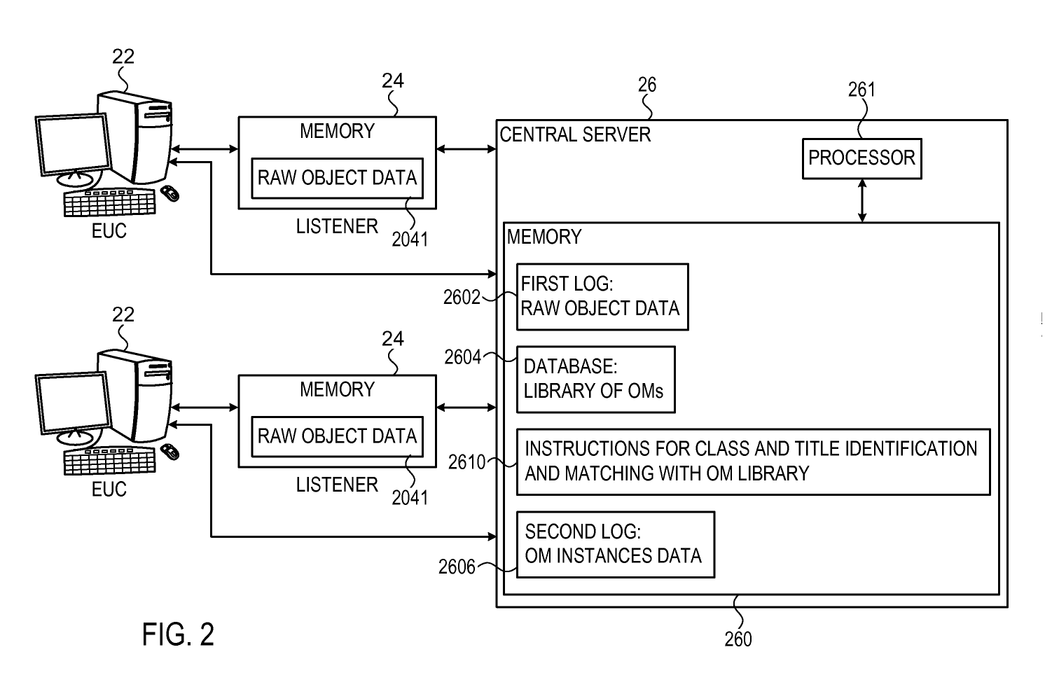

A second system (FIG. 2) comprising a number of PCs (EUCs) (22) running on the MS Windows operating system and connected to the Internet, each provided with listener software (24); a dedicated remote computer (26), running on Microsoft Server operating system and connected to the Internet; an RSA based cryptographic software on PCs and server providing a secure channel of communications over the Internet. The server is provided with a memory device (260) storing an updatable library of object models (OMs) (2604) and a log of OM Instances (2606).

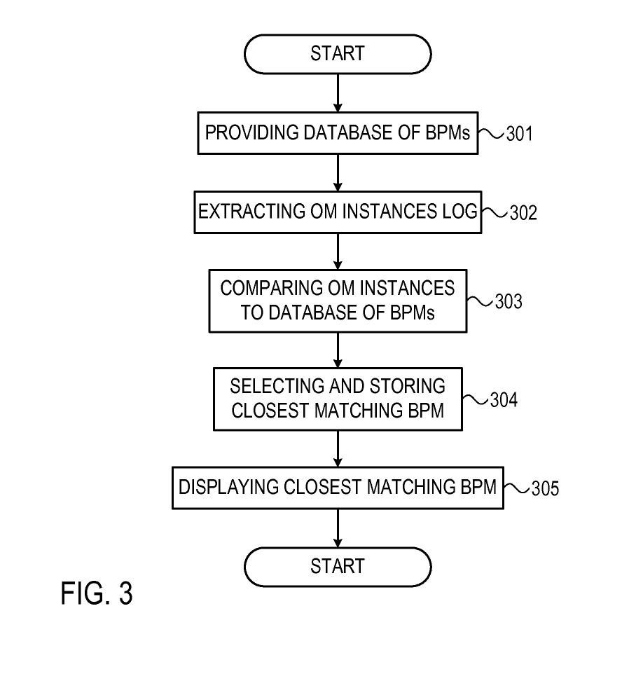

An exemplary method disclosed and enabled by the present invention is as follows (FIG. 3) Providing a database containing a plurality of business process models (BPMs) (301); Extracting OM instance log (302) from a system for automatically interpreting object usage on end user computers (the method of operation of said system is described below); Comparing contents of said OM instance log to at least one of said plurality of said business process models for distance with respect to a structural similarity metric (303);Selecting and storing (304) closest match with respect to said metric; and Displaying graphically said closest match (305) using BPMN notation.

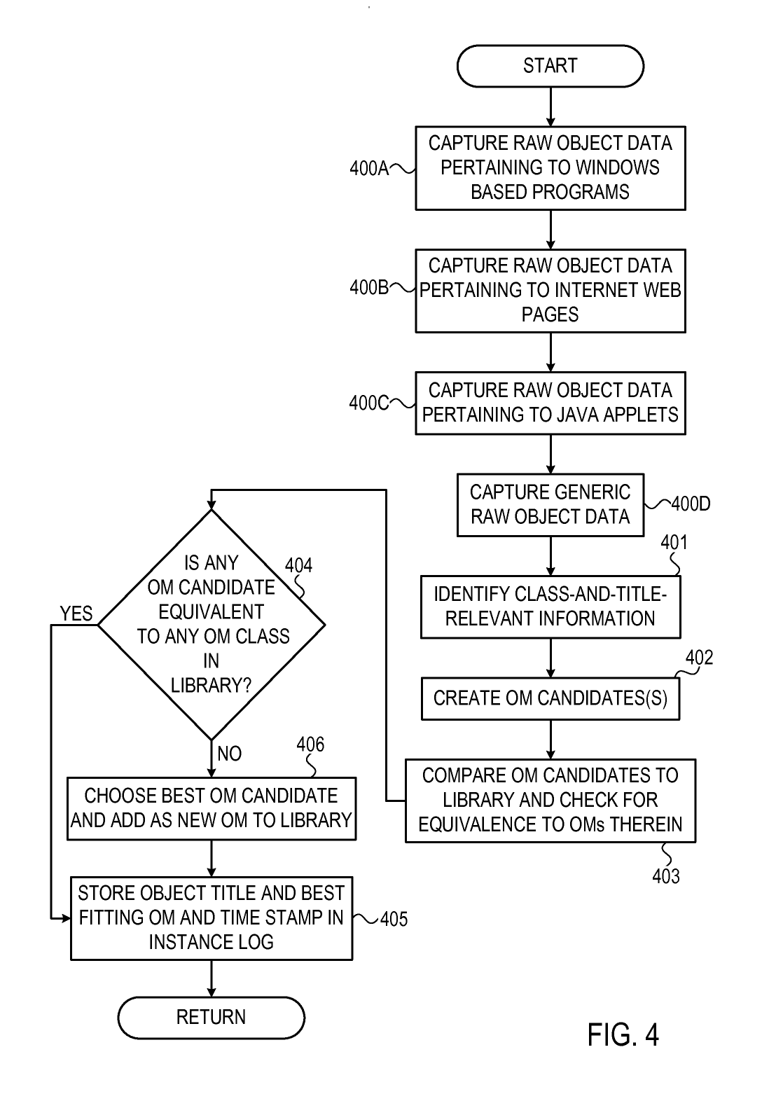

An exemplary second method (FIG. 4) disclosed and enabled by the present invention for extracting an OM instance log is as follows: The listener software on each PC retrieves data on usage of Windows based programs using Windows system calls, DLL injection and system events (capture raw object data pertaining to Windows based programs) (400a); additionally, the listener uses a Browser Helper Object (BHO) plugin to access Document Object Model (DOM) of web pages in use (capture raw object data pertaining to Internet web pages) (400b); data on Java applets is captured using the Java software platform (capture raw object data pertaining to Java applets) (400c); further the Microsoft User Interface Automation is used to collect information about user interface elements (capture generic raw object data) (400d). The listener program on each PC transmits said captured data to server via the secure channel. On the server, a program analyzes the captured raw data for information pertaining to the class and value of objects (identify class- and title-relevant information, 401), and creates for each object object a candidate object model (OM) (create OM candidates, 402). The program then further compares the candidate OMs with OMs in said library (compare OM candidates to library and check for equivalence to OMs therein, 403), and stores object title, best fitting OM and time stamp in instance log (405). For objects lacking any matching OMs, the candidate OM is promoted to OM status by adding it to the library (406), and the match to new OM is recorded in log together with time stamp (405).

What is claimed is:

1) A system for mining business processes comprising:
a) an Object Model (OM) instance log extracting means;
b) a computer readable medium containing:
i) an OM instance log obtained from said extracting means;
ii) a first database containing a plurality of business process models (BPMs);
iii) instructions for automatically ranking according to a predetermined metric, the matching of the contents of said OM instance log to at least one of said plurality of said business process models;
iv) a second log of closest match for each of said OM instance, according to said ranking; and
c) a displaying means for displaying said log closest match,
wherein said OM instance log derives from a second system for automatically interpreting screen usage on a plurality of end users' computers.

2) The system of claim 1 wherein said second system comprises:
a. a plurality of computers used by end users (EUCs);
b. a central server (server) with processing means and first information storage means adapted for storing:
i. captured raw object data;
ii. an updatable library of object classes;
iii. computer readable instructions for identifying class-relevant and title-relevant information in raw object data and comparing to said library of object classes, or object models (OMs);
iv. a log of OM instances, comprising data on class, title, time and duration of usage of said OM instances; and,
v. a plurality of listener devices (listeners) possessing a second information storage means and first means of communications with one or more EUCs, and adapted for obtaining from said EUCs information on object activity, and a second means of communication with server for passing said object usage information.

3) The system of claim 2 wherein said server processing means further comprises:
a) an identifying means for object class-relevant and title-relevant information in raw object data;
b) a computer readable medium carrying instructions for automatically creating OM candidates; and
c) a computer readable medium carrying instructions for comparing to said candidates to updatable library of OMs.

4) The system of claim 2 wherein said server processing means further comprises a computer readable medium storing instructions for determining the assignation of an existing class to OM instance according to predetermined criteria or conferring permanent class status to OM candidate by adding it to said updatable library of classes, server further recording assigned class, as well as title and object usage information in said object instance log.

5) The system of claim 1 wherein said BPM database is updatable and further wherein said computer readable medium further comprises stored instructions for discovery of new BPMs and for adding them to updatable BPM database.

6) The system of claim 1 wherein said displaying means comprises storage and processing means and further wherein said storage means stores instructions for displaying BPMs in BPMN notation conforming to BPMN standard set by the the Object Management Group consortium;

7) The system of claim 5 wherein said updatable BPM database is encoded in the XML Process Definition Language (XPDL) which is a standard supported by the Workflow Management Coalition (WfMC) consortium;

8) The system of claim 5 wherein said instructions for discovery of new BPMs comprise data mining algorithms from the open source software suite ProM.

9) The method according to claim 8, wherein said method for automatically interpreting screen usage on end user computers comprises obtaining a plurality of computers used by end users (EUCs);
c. a central server with processing means and first information storage means adapted for storing:
i. captured raw object data;
ii. an updatable library of object classes;
iii. computer readable instructions for identifying class-relevant and title-relevant information in raw object data and comparing to said library of object classes, or object models (OMs);
iv. a log of OM instances, comprising data on class, title, time and duration of usage of said OM instances; and,
d. a plurality of listener devices (listeners) possessing a second information storage means and first means of communications with one or more EUCs, and adapted for obtaining from said EUCs information on object activity, and a second means of communication with server for passing said object usage information;
said server processing means comprising an identifying means for object class-relevant and title-relevant information in raw object data, instructions for creating OM candidates and comparing to said candidates to updatable library of OMs and determining either the assignation of an existing class to OM instance according to predetermined criteria or conferring permanent class status to OM candidate by adding it to said updatable library of classes, server further recording assigned class, as well as title and object usage information in said object instance log.

10) The system of claim 5 wherein said instructions for discovery of new BPMs comprise data mining algorithms selected from the group consisting of the proprietary software tools Futura Reflect and Interstage Automated Process Discovery and BPMone and Nitro and ARIS Process Performance Manager and QPR Process Analyzer.

11) A method for discovering business processes comprising steps of:
a) obtaining a system for mining business processes said system comprising:
i) an Object Model (OM)instance log extracting means;
ii) a computer readable medium containing:
(a) an OM instance log obtained from said extracting means;
(b) a first database containing a plurality of business process models (BPMs);
(c) instructions for automatically ranking according to a predetermined metric, the matching of the contents of said OM instance log to at least one of said plurality of said business process models;
(d) a second log of closest match for each of said OM instance, according to said ranking; and,
(e) a displaying means (14) for displaying said log closest match,
wherein said OM instance log derives from a second system for automatically interpreting screen usage on a plurality of end users' computers; and,
b) operating said system.

12) A method for discovering business processes comprising steps of:
a) Providing a database containing a plurality of business process models (BPMs);
b) Extracting OM instance log from a system for automatically interpreting screen usage on end user computers;
c) Comparing contents of said OM instance log to at least one of said plurality of said business process models for distance with respect to predetermined metric;
d) Selecting and storing closest match with respect to said metric; and
e) Displaying said closest match,
wherein said extracting of OM instance log is generated via a second method for automatically interpreting object usage on a plurality of end users' computers.
